(19) United States
(12) Patent Application Publication
(10) Pub. No.: US 2015/0022535 A1
(43) Pub. Date: Jan. 22, 2015

(54) Distributed Graphics Processing

(71) Applicants: Chengming Zhao, Shanghai (CN); Tao J. Zhao, Shanghai (CN); John J. Weast, Portland, OR (US)

(72) Inventors: Chengming Zhao, Shanghai (CN); Tao J. Zhao, Shanghai (CN); John J. Weast, Portland, OR (US)

(21) Appl. No.: 13/991,494

(22) PCT Filed: Dec. 4, 2012
(86) PCT No.: PCT/CN2012/085839

§ 371 Date: Jun. 4, 2013

(51) Int. Cl. G06F 3/14; G06T 11/60; G06T 1/20

(52) U.S. Cl. CPC G06F 3/14; G06T 1/20; G06T 11/60
USPC 345/520

(57) ABSTRACT

In accordance with some embodiments, stability of remote graphics processing may be improved by parallelizing the original high resolution graphics data processing into multiple lower resolution graphics data processed on the remote device. If some remote connections are down, the client graphics application can still generate the final screen image, with lower definition, from the rest of the resulted images to ensure that the frame is not dropped.

### BACKGROUND

This relates generally to graphics processing.

In some cases, it is advantageous to offload graphics processing tasks from a local device to a remote server. For example, graphics processing could be offloaded from a local device with limited processing capabilities to the Cloud. In addition graphics processing tasks could be offloaded from one device to other devices in a peer-to-peer arrangement.

Many times, the quality of the remote graphics processing depends on the connection between the client and the remote device. If the connection is down, a frame will be dropped because of missing graphics data. This may occur when the network degrades or when the remote server shuts down or is out of the network.

### BRIEF DESCRIPTION OF THE DRAWINGS

Some embodiments are described with respect to the following figures:

FIG. 1 shows decomposition of an image in accordance with one embodiment to the present invention;

FIG. 2 shows image recovery in accordance with one embodiment of the present invention;

FIG. 3 is a schematic depiction of one embodiment of the present invention;

FIG. 4 is a flow chart for one embodiment of the present invention on the client;

FIG. 5 is a flow chart for one embodiment of the present invention on the server for a remote device;

FIG. 6 is a system depiction for one embodiment; and

FIG. 7 is a front elevational view of one embodiment.

### DETAILED DESCRIPTION

In accordance with some embodiments, stability of remote graphics processing may be improved by parallelizing the original high resolution graphics data processing into multiple lower resolution graphics data processed on the remote device. If some remote connections are down, the client graphics application can still generate the final screen image, with lower definition, from the rest of the resulted images to ensure that the frame is not dropped.

A packet dispatch agent and a packet recovery agent may be provided in the referring client. The packet dispatch agent decomposes the original image related data of an application program interface (API) into multiple low resolution images. Each remote device executes the graphics application program interface calls on the low resolution image data. Then the resulting images are sent back to a packet recovery agent to generate the final screen display. The decomposition of the original image related data could be decomposition of raw RGB data, coordination data, alpha blending or rotating.

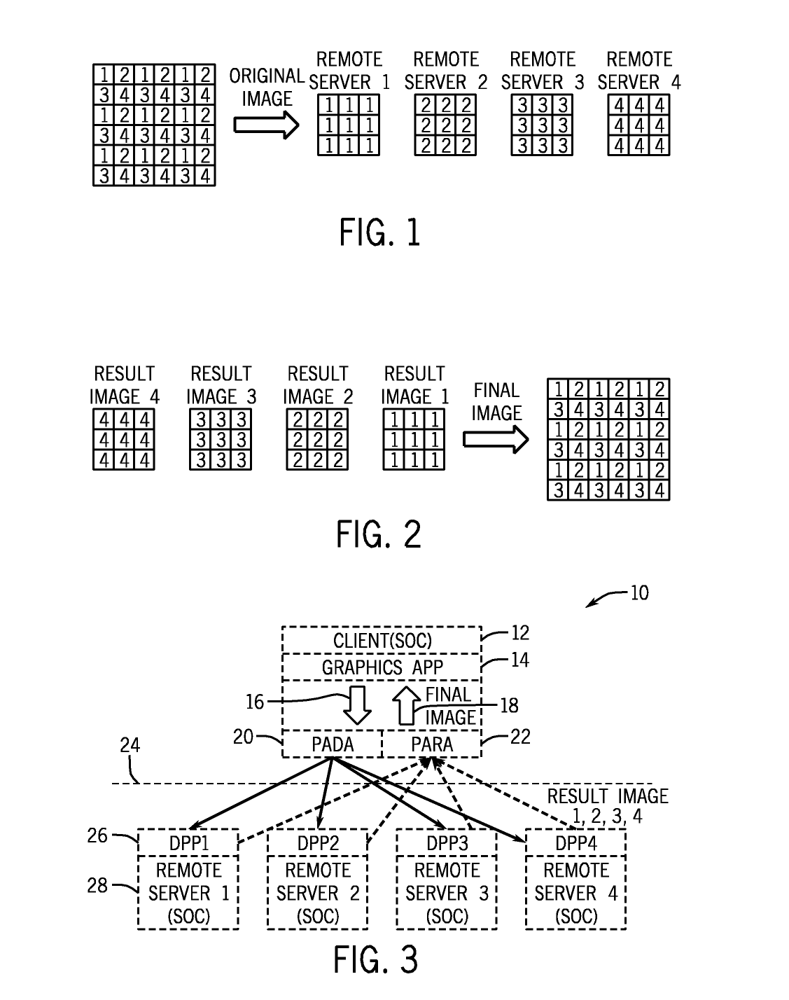

Referring to FIG. 1, the packet dispatch agent on the client intercepts the graphics API calls on the client and sends the graphics calls to the server or a remote device cluster. Typical techniques for doing this involve DirectFB voodoo and VirtualGL. Before the graphics API calls are sent out, the packet dispatch agent decomposes the image related data and sorts the data to a plurality (e.g. four) separate remote devices. Otherwise, it may sort the decomposed images into any number of available remote devices. Then the original image data is sent in pieces to the remote server.

As shown in FIG. 1, a 6×6 array of cells can be broken into four 3×3 arrays, each sent to a different remote server or remote device for independent processing. The three by three arrays may each be selected from regularly spaced pixel positions.

Then every remote server only needs to process the original data for each of the four cells. If one cell is lost, the original image can still be reconstructed even at lower resolution from the remaining three servers.

The packet recovery agent on the client generates the final image from the resulting images sent by the remote server cluster. In distributed graphics processing, all the API calls may be executed on the server. Then the resulting image is sent back to the client for rendering. This is in accordance with an embodiment using VirtualGL. This is a reverse process from the packet dispatch agent.

As shown in FIG. 2, the four resulting images are recombined into the original image.

If any connection to a server is broken, the packet recovery agent recovers the lost image data based on adjacent pixels of the other images. For example, if server 1 is down, the estimation of the result of image 1 can be based on the average of the values from the adjacent pixels from the other three servers, in this case the images 2, 3, and 4. The definition may well be lower but frame dropping may be avoided in some cases.

Referring to FIG. 3, a client 12 may be a system or a system on a chip (SOC) that interfaces over a network 24 with distributed processing proxies 26 associated with each of a plurality of remote servers 28 defining a server cluster, in this case, numbered 1 through 4, which may also be systems on a chip. The client includes a memory 14 storing a graphics application, the packet dispatch agent 20, and the packet recovery agent 22. The final image 18 is passed from a packet recovery agent 22 to the graphics application. The original image 16 is passed to a packet dispatch agent from the graphics application.

In an example using OpenGL, the graphics application launches on a client. The packet dispatch agent intercepts an API call, such as glDrawPixels, to decompose the image data and dispatch the plurality of decomposed images to the remote servers. Besides image data, the packet dispatch agent may change related data such as coordination and size. The distributed processing proxy 26 handles the API call from the client to execute the API call on the server. When glFinish or eglSwapBuffer is called, the distributing processing proxy sends the resulting image to the client and particularly the packet recovery agent 22. The size of the image data received on the server generally is one quarter of the original size when the image is split four ways as depicted. Of course other splits may also be done.

The packet recovery agent 22 receives the resulting images from the remote servers and generates the final image. If one connection is down, the lost resulting image may be recovered based on interpolation of values from adjacent pixels which can be found in other resulting images.

For example if a result image 1 is down, it can be recovered by the following pseudo-code:

four each i, j in Width, Height of final screen {rgb [i][j]=(rgb[i−1][j]+rgb[i+1][j]+rgb[i][j−1]+rgb[i][j+1])/4}

rgb[i−1][j] and rgb[i+1][j] can be found in resulting image 2

rgb[i][j−1] and rgb[i][j+1] can be found in resulting image 3

Then the graphics application 14 renders the final image to the client's screen. As an example, the local client may be a mobile tablet and the remote device could be the Cloud. Other examples of the local client include a tablet or other mobile device.

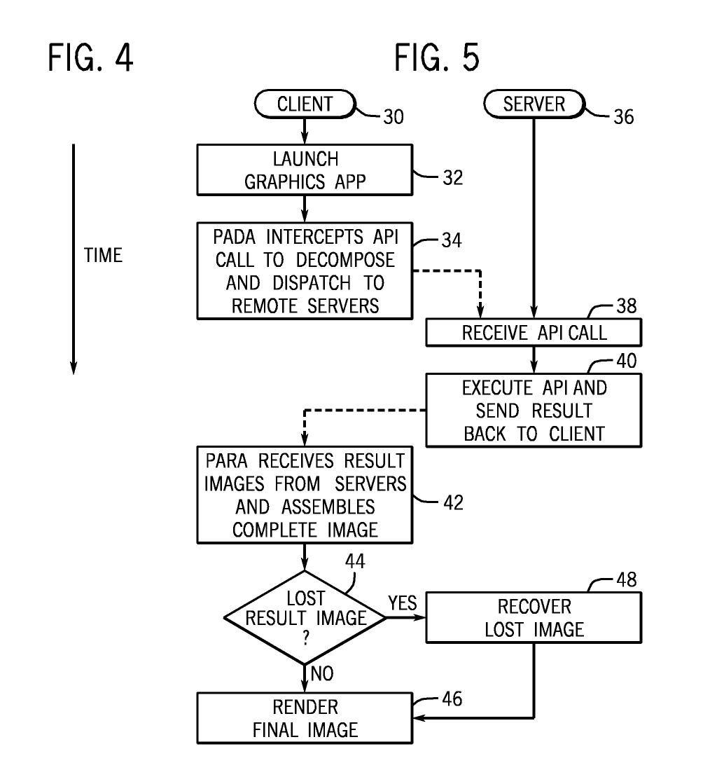

Thus, referring to FIGS. 4 and 5, two flows are shown in order to illustrate the interaction between the code on the client 30 and the code on the server 36. While a software based environment is envisioned, the sequences shown in FIGS. 4 and 5 can also be implemented in firmware and/or hardware. In software and firmware embodiments, the sequences may be implemented by computer executed instructions stored in one or more non-transitory computer readable media such as magnetic, optical or semiconductor storages.

Referring first to FIG. 4, the client sequence 30 begins by launching the graphics application as indicated in block 32. The packet dispatch agent intercepts the API call to decompose and dispatch the image to remote servers as indicated in block 34. As shown in dashed lines, the flow then moves to the server 36 which receives the API call as indicated in block 38, the server cluster executes the API call in distributed servers and sends the results back to the client as indicated in block 40. As indicated by dashed lines, the flow returns to the client 30 where the packet recovery agent receives the resulting images from the servers and then assembles the complete image as indicated in block 42.

A check at diamond 44 determines whether all the image data was received from all the servers. If so, the final image is rendered as indicated in block 46. Otherwise the lost image is recovered using interpolation, averaging or other techniques as indicated in block 48 and then the final image is rendered at block 46.

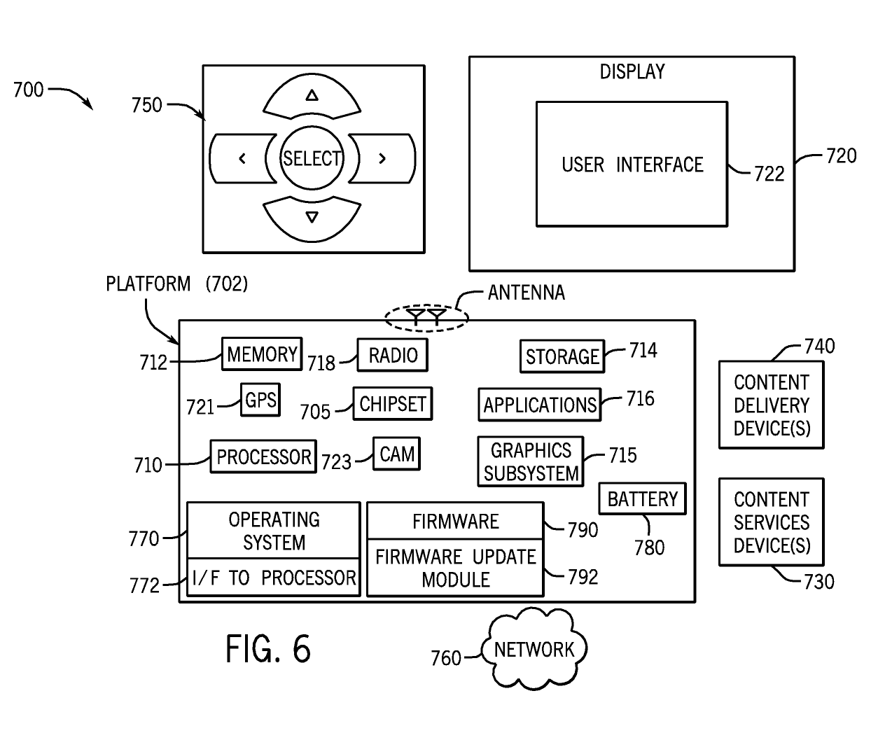

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequences shown in FIGS. 4 and 5 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

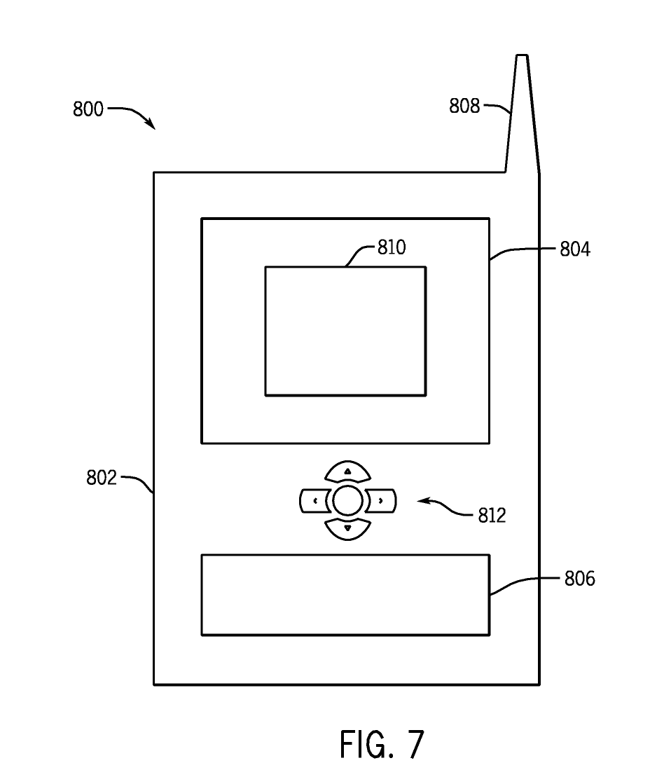

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
dividing an image into a plurality of sub-images; and
transmitting said sub-images for processing on a server cluster.

2. The method of claim 1 including reconstructing a processed image composed of decomposed resulting images received from said cluster.

3. The method of claim 2 including receiving less resulting images than a number of sub-images sent to said cluster.

4. The method of claim 3 including reconstructing a composite image by calculating image data to make up for a missing resulting image.

5. The method of claim 4 including averaging the received final images to reconstruct said composite image.

6. A method comprising:
receiving in a server cluster a plurality of sub-images from a client;
processing said sub-images in separate servers; and
sending resulting sub-images to said client.

7. The method of claim 1 including using a distributed processing proxy in each server.

8. One or more non-transitory computer readable media storing instructions executed by a computer to perform a sequence comprising:
dividing an image into a plurality of sub-images; and
transmitting said sub-images for processing on a server cluster.

9. The media of claim 8, further storing instructions to perform a sequence including reconstructing a processed image composed of decomposed resulting images received from said cluster.

10. The media of claim 9, further storing instructions to perform a sequence including receiving less resulting images than a number of sub-images sent to said cluster.

11. The media of claim 10, further storing instructions to perform a sequence including reconstruction a composite image by calculating image data to make up for a missing resulting image.

12. The media of claim 11, further storing instructions to perform a sequence including averaging the received final images to reconstruct said composite image.

13. A client comprising:
a processor;
a memory coupled to said processor;
a first agent to divide a graphics processing workload into parts; and
a second agent to receive processed parts from a remote server and reassemble the parts.

14. The client of claim 13, said second agent to reconstruct a processed image composed of decomposed resulting images received from said remote server.

15. The client of claim 14, said second agent to reconstruct a composite image when less than all the parts of an image are received from said server.

16. The client of claim 15, said second agent to reconstruct an image by calculating image data for said missing part from one or more received parts.

17. The client of claim 16, including averaging received parts to reconstruct a composite image.

18. The client of claim 13 including an operating system.

19. The client of claim 13 including a battery.

20. The client of claim 13 including firmware and a module to update said firmware.
